(19) United States
(12) Patent Application Publication
(10) Pub. No.: US 2003/0192973 A1
(43) Pub. Date: Oct. 16, 2003

(54) Cloth and container for recording material using same

(75) Inventors: Satoru Turumaki, Kanagawa (JP); Masazumi Tomoda, Fukui (JP); Toshihiro Kondou, Fukui (JP); Yuichi Sasaki, Kanagawa (JP)

Correspondence Address: SUGHRUE MION, PLLC, 2100 PENNSYLVANIA AVENUE, N.W., WASHINGTON, DC, 20037, US

(73) Assignees: FUJI PHOTO FILM CO., LTD.; ARON EVER-GRIP LTD.; SEIREN Co., LTD.

(21) Appl. No.: 10/413,528

(22) Filed: Apr. 15, 2003

(30) Foreign Application Priority Data
Apr. 16, 2002 (JP) 2002-113954
Sep. 24, 2002 (JP) 2002-276530

(51) Int. Cl. G03B 23/02; G11B 23/107; G03C 3/02; G03B 17/26; B32B 27/04; B32B 27/12

(52) U.S. Cl. 242/348.4; 396/513; 430/501; 442/281

(57) ABSTRACT

There is provided a light-shielding cloth that includes a base fabric and an adhesive provided as a coating on the reverse side of the base fabric, the adhesive containing carbon black. There is also provided a light-shielding container for a light-sensitive material, the container having a slit-shaped opening through which the light-sensitive material is inserted into and taken out of the container, and the light-shielding cloth being bonded to the opening. There is also provided a recording material container that uses an adhesive containing a hydrogenated tackifying resin as a tackifying resin component. There is also provided a cloth that includes a base fabric and an adhesive provided as a coating on the reverse side of the base fabric, the adhesive containing a hydrogenated tackifying resin as a tackifying resin component, and a light-shielding container for a light-sensitive material, the container having a slit-shaped opening to which this cloth is bonded.

### BACKGROUND OF THE INVENTION

1. Field of the Invention

The present invention relates to a container for housing a light-sensitive material such as photographic printing paper, light-sensitive material for printing or color negative film for photography, as well as a light-insensitive recording material such as thermal transfer image receiving paper. Furthermore, the present invention relates to a cloth, and preferably a light-shielding cloth, that is provided on a slit-shaped opening of such a container housing a recording material, and particularly a light-sensitive material, which is inserted and taken out through the opening.

2. Description of the Related Art

Photographic 35 mm roll film, etc. is used in a state in which it is housed in a light-shielding container called a cartridge (also called a ‘magazine’). As is well known, this cartridge is basically formed from a cylindrical iron shell, a spool as a core for winding the film housed in the shell in roll form, and two caps for closing the two ends of the shell. Moreover, light-shielding cloth, generally called plush (also called ‘teremp’), is bonded to the inner surfaces of a film passage opening of the above-mentioned shell.

Since the light-shielding cloth is required to prevent unused film from being exposed to light and should also not interfere with the smooth drawing out and rewinding of the film, a light-shielding cloth made of a flexible material having a pile on the surface of a base fabric is used as the light-shielding cloth.

Conventionally, light-shielding cloth of this kind is produced by weaving or knitting two superimposed woven or knitted cloths with a pile thread so as to combine the cloths thus giving doubled woven or knitted cloths, and then cutting the pile thread on a plane that is located substantially centrally between the two woven or knitted cloths (ref. JU-A-4-18844 (JU-A denotes a Japanese unexamined utility model application publication), JU-A-4-18846, JU-A-4-28641, and JP-A-4-73642 (JP-A denotes a Japanese unexamined patent application publication)). In this plush, the pile threads are in contact with the photographic film so preventing the film from being exposed to light, and the flexibility and resistance to drawing out of the photographic film are sufficient for ordinary use.

Conventionally, with regard to a method for improving the light-shielding performance of a light-shielding cloth employing pile threads (pile woven cloth and pile knitted cloth), there is a method in which the pile density of a pile woven cloth or a pile knitted cloth used as a light-shielding member is increased, a method in which the gap of an opening of a photographic film magazine through which a film is inserted into and taken out of the magazine is reduced, and a method as disclosed in JU-A-4-28641 in which the erect state of the pile is maintained by using special threads, thus preventing collapse of the pile.

The plush is designed so as to block light from entering through a slit-shaped opening, that is, a port of a light-shielding container, and it is also important for the plush not to affect the photographic properties. Affecting the photographic properties means the occurrence in a photographic film of fogging, abnormal density, abnormal sensitivity, abnormal gradation, abnormal color, uneven density, etc., and the main causative factors can be roughly divided into physical factors due to a packaging material and chemical factors due to a chemical reaction, etc. between the photographic film and photographically harmful substances contained in the packaging material.

With regard to the physical factors, for example, if foreign matter is attached to the plush, then extra pressure is applied to the photographic film, thereby causing pressure fogging or film scratches. Furthermore, when the material of the plush and the photographic film base are widely separated in the triboelectric series, the plush is electrostatically charged, particularly when the photographic film is taken out of the cartridge in low humidity, and the static electricity causes a static mark (branched or blurred circular fogging). With regard to the chemical factors, for example, there is a chemical reaction between the photographic film and a harmful gas such as an aldehyde compound, ketone, a sulfur compound, or a cyanide compound generated by thermal decomposition of a thermoplastic resin, which causes gas fogging in the photographic film, deterioration in sensitivity, abnormal sensitivity, etc. Since the aldehyde compound is harmful to the human body, it is preferable to minimize the generation thereof.

A tackifying resin such as a rosin, a rosin derivative, a terpene resin, or a petroleum resin is used as a starting material for a conventional hot-melt adhesive for the plush (ref., H. Fukada, ‘Hotto Meruto Secchaku no Jissai (Hot-melt Adhesion In Practice)’, 5th Printing, Published by Kobunshi Kankokai KK, May 20, 1979, first edition, or ‘Hotto Meruto Secchakuzai no Jissai Gijutsu (Practical Techniques for Hot-melt Adhesives)’, Popular Edition, 1st Printing, CMC Publishing Co., Ltd., Aug. 30, 1991, first edition, first printing, etc.). However, there are problems such as abnormal density, abnormal sensitivity, abnormal gradation, abnormal color and uneven density, particularly in an area where the plush and the photographic film are in contact with each other, depending on the environment where the photographic film is used, and particularly in summer when a camera loaded with film is left in, for example, a high temperature, high humidity room or in a car.

Moreover, the conventional adhesive for the plush cannot ensure sufficient adhesive strength of the plush to the cartridge shell, the plush can be detached when a lid member or a base member of the photographic film cartridge is fitted into the upper or lower part of a tube-forming section, and light can enter through the gap thus formed by the detachment, thereby causing the problem of light fogging. Furthermore, there are the problems that, depending on the environment in which the photographic film is used, the plush might become detached from the cartridge shell and, in particular, if a camera loaded with the photographic film is left in a car in summer, the camera and an area of the plush that has been coated with the adhesive might become bonded together, thus not only contaminating the camera, but also preventing the photographic film from being taken out.

### BRIEF SUMMARY OF THE INVENTION

The present invention has been carried out in order to solve the above-mentioned problems, and it is a first object thereof to provide a container for any recording material, including both light-sensitive and light-insensitive materials, the container allowing the recording properties of the recording material to be maintained. It is a second object thereof to provide a cloth that has sufficient adhesive strength and does not affect photographic properties. It is a third object of the present invention to provide a light-shielding container for a light-sensitive material such as a photographic film, the container employing a light-shielding cloth that has sufficient adhesive strength and does not affect the photographic properties.

The problems to be solved by the present invention can be solved by a cloth and a recording material container as follows.

1) A light-shielding cloth comprising a base fabric and an adhesive provided as a coating on the reverse side of the base fabric, the adhesive containing carbon black.

2) A light-shielding container for a light-sensitive material, the container having a slit-shaped opening through which the light-sensitive material is inserted into and taken out of the container, wherein the light-shielding cloth according to 1) is bonded to the opening.

3) The light-shielding cloth according to 1), wherein the adhesive is a hot-melt adhesive.

4) A recording material container comprising use of an adhesive containing a hydrogenated tackifying resin as a tackifying resin component.

5) A non-light-shielding cloth or a light-shielding cloth comprising a base fabric and an adhesive provided as a coating on the reverse side of the base fabric, the adhesive containing a hydrogenated tackifying resin as a tackifying resin component.

6) The recording material container according to 4), wherein the hydrogenated tackifying resin is an alicyclic hydrogenated petroleum resin.

7) The non-light-shielding cloth or the light-shielding cloth according to 5), wherein the hydrogenated tackifying resin is an alicyclic hydrogenated petroleum resin.

8) The recording material container according to 4), wherein carbon black is added to the adhesive.

9) The non-light-shielding cloth or the light-shielding cloth according to 5), wherein carbon black is added to the adhesive.

10) The recording material container according to 6), wherein carbon black is added to the adhesive.

11) The non-light-shielding cloth or the light-shielding cloth according to 7), wherein carbon black is added to the adhesive.

12) A light-shielding container for a light-sensitive material, the container having a slit-shaped opening through which the light-sensitive material is inserted into and taken out of the container, wherein the light-shielding cloth according to 5) is bonded to the opening.

13) A light-shielding container for a light-sensitive material, the container having a slit-shaped opening through which the light-sensitive material is inserted into and taken out of the container, wherein the light-shielding cloth according to 7) is bonded to the opening.

14) A light-shielding container for a light-sensitive material, the container having a slit-shaped opening through which the light-sensitive material is inserted into and taken out of the container, wherein the light-shielding cloth according to 9) is bonded to the opening.

15) A light-shielding container for a light-sensitive material, the container having a slit-shaped opening through which the light-sensitive material is inserted into and taken out of the container, wherein the light-shielding cloth according to 11) is bonded to the opening.

16) The light-shielding container for a light-sensitive material according to 12), wherein the adhesive is a hot-melt adhesive.

17) The light-shielding container for a light-sensitive material according to 12), wherein the hydrogenated tackifying resin has a degree of hydrogenation of at least 80%.

18) The light-shielding container for a light-sensitive material according to 12), wherein the light-sensitive material is a 135 type film cartridge.

19) The light-shielding container for a light-sensitive material according to 12), wherein the container houses a photographic film employing a reduction-sensitized silver halide emulsion.

Preferred embodiments of the light-shielding cloth are listed below.

20) The light-shielding cloth according to 1) or 3) wherein the amount of carbon black added to the adhesive is 0.2 to 1.0 wt %,

21) the light-shielding cloth according to 1), 3), or 20) wherein the amount of adhesive coated is 60 to 150 g/m²,

22) the light-shielding cloth according to any one of 1), 3), 20) and 21) wherein a phenolic antioxidant is added to the adhesive,

23) the light-shielding cloth according to any one of 1), 3), and 20) to 22) wherein the light-shielding cloth is cut by an ultrasonic slitter to give a narrow width, and

24) the light-shielding cloth according to 23), wherein the ‘narrow width’ is a width of 2 to 30 mm.

Preferred embodiments of the light-shielding container for a light-sensitive material according to 2) are listed below.

25) The light-shielding container for a light-sensitive material according to 2), wherein the adhesive is a hot-melt adhesive,

26) the light-shielding container for a light-sensitive material according to 2) or 25), wherein the amount of carbon black added to the adhesive is 0.2 to 1.0 wt %,

27) the light-shielding container for a light-sensitive material according to 2), 25), or 26), wherein the amount of adhesive coated is 60 to 150 g/m²,

28) the light-shielding container for a light-sensitive material according to any one of 2), and 25) to 27), wherein a phenolic antioxidant is added to the adhesive,

29) the light-shielding container for a light-sensitive material according to any one of 2), and 25) to 28), wherein the base fabric is a woven structure or a knitted structure,

30) the light-shielding container for a light-sensitive material according to 29), wherein the knitted structure is formed from a chain thread and an inlay thread,

31) the light-shielding container for a light-sensitive material according to any one of 2), and 25) to 30), wherein the container is a 135 type film cartridge,

32) the light-shielding container for a light-sensitive material according to any one of 2), and 25) to 31), wherein the container houses a reduction-sensitized photographic film,

33) the light-shielding container for a light-sensitive material according to any one of 2), and 25) to 32) wherein the light-shielding cloth is cut by an ultrasonic slitter to give a narrow width, and

34) the light-shielding container for a light-sensitive material according to 33), wherein the ‘narrow width’ is a width of 2 to 30 mm.

Preferred embodiments of the recording material container according to 4), 6), 8), or 10) are listed below.

35) The recording material container according to 4), 6), 8), or 10), wherein the adhesive is a hot-melt adhesive,

36) the recording material container according to 4), 6), 8), 10), or 35), wherein the recording material is a heat developable light-sensitive material image receiving paper, which is a transfer-system image receiving paper, or an ink-jet image receiving paper,

37) the recording material container according to 4), 6), 8), 10), 35), or 36), wherein the container houses a long length of a recording material roll, and

38) the recording material container according to any one of 4), 6), 8), 10), and 35) to 37), wherein the hydrogenated tackifying resin has a degree of hydrogenation of at least 80%.

Preferred embodiments of the non-light-shielding cloth or the light-shielding cloth according to 5), 7), 9), or 11) are listed below.

39) The non-light-shielding cloth or the light-shielding cloth according to 5), 7), 9), or 11), wherein the adhesive is a hot-melt adhesive,

40) the non-light-shielding cloth or the light-shielding cloth according to 5), 7), 9), 11), or 39), wherein the hydrogenated tackifying resin has a degree of hydrogenation of at least 80%,

41) the non-light-shielding cloth or the light-shielding cloth according to 5), 7), 9), 11), 39), or 40), wherein the base fabric is a woven structure or a knitted structure, and

42) the non-light-shielding cloth or the light-shielding cloth according to any one of 5), 7), 9), 11), and 39) to 41), wherein the base fabric is a knitted structure formed from a chain thread and an inlay thread.

### BRIEF DESCRIPTION OF THE SEVERAL VIEWS OF THE DRAWINGS

FIG. 1 is a front view of one example of a shell-section-forming metal sheet in which light-shielding plush is affixed to both the right and left edges thereof using long lengths of the light-shielding plush of the present invention.

FIG. 2 is a perspective view of one example of a shell-section-forming metal sheet provided with a step, preferably used when the long lengths of the light-shielding plush of the present invention both have a width of 8.8 to 9.7 mm.

FIG. 3 is a cross section of one example of a photographic film cartridge using the shell-section-forming metal sheet with the light-shielding plush shown in FIG. 1.

### DETAILED DESCRIPTION OF THE INVENTION

The cloth and, in particular, the light-shielding cloth of the present invention comprise a base fabric section (also called base fabric part’) and a pile section (also called ‘pile part’) formed from a pile incorporated into the base fabric section so that the pile section is formed from a dense erect pile having a uniform length. The pile here is formed from multi-filament. With regard to representative examples of the plush base fabric used in the present invention, there are those having a woven structure comprising a warp and a weft, those having a knitted structure comprising a chain thread and an inlay thread, and napped woven or knitted fabrics. In the present invention the base fabric preferably has a woven structure or a knitted structure, and most preferably a knitted structure.

The base fabric side, that is, the reverse side of the base fabric of the plush of the present invention may be coated with a sealant. The sealant has an effect of preventing an adhesive from penetrating from the reverse side (coated side) to the surface, particularly when the adhesive has a low viscosity.

Examples of the sealant include, as disclosed in JP-A-62-55699, JP-A-62-71949, JP-A-62-27733 and JP-A-2-72348, synthetic emulsions of polyvinyl, polyolefin, polyurethane, polyamide, polyester, synthetic rubber, epoxy, phenol, and other acrylics, blended emulsions of more than one type chosen from the above-mentioned synthetic emulsions, and copolymer emulsions obtained by combining the above-mentioned components. When the way in which the adhesive is soaked up into the light-shielding cloth can be adjusted by the adhesive alone, as disclosed in JP-B-5-88455 (JP-B denotes a Japanese examined patent application publication), it is unnecessary to apply the sealant, and this is preferred from the viewpoint of cost, simplicity of equipment, etc.

The cloth of the present invention employs an adhesive for bonding the cloth and the recording material container. Examples of the adhesive are disclosed in JP-B-56-20535, JP-A-61-289347, JP-A-62-55649, JP-A-62-27733, JP-B-5-88456, JP-B-6-52399, and JP-B-6-52403. Specific examples thereof include commercial double-sided adhesive tapes, adhesives based on, for example, polyolefins such as polyethylene, vinyl acetate copolymers such as ethylene-vinyl acetate copolymer, acrylic acid copolymers such as ethylene-ethyl acrylate and ethylene-isobutyl acrylate, polyamides such as nylon-6, nylon-6,6, nylon-10, nylon-12, and N-methoxymethylated nylon, polyesters such as terephthalic acid types, polyvinyl butyrals, poly(vinyl acetates), cellulose derivatives such as cellulose acetate, methylcellulose and cellulose acetate butyrate, polymethacrylate esters such as poly(methyl methacrylate), poly(vinyl ethers) such as poly(vinyl methyl ether), polyurethanes, polycarbonates, styrene block copolymers such as styrene-ethylene-butylene-styrene, synthetic rubbers such as styrene butadiene, isoprene and butyl rubber, other special rubbers and other acrylic copolymers, and mixtures of more than one type of adhesive chosen from the above-mentioned adhesives.

From the viewpoint of the cost and environmental compatibility, the adhesive is preferably a ‘hot-melt adhesive’ that has as a main component a thermoplastic resin, has 100% solids content with no solvent, and is solid at normal temperature. Hot-melt adhesives are described in ‘Secchaku (Adhesion) Handbook, Second Edition (Ed. by The Adhesive Society of Japan)’, published by The Nikkan Kogyo Shimbun, Ltd., etc.

The explanation below centers on the hot-melt adhesive, which is preferably used as the adhesive in the present invention.

The hot-melt adhesive generally contains as essential components a base polymer and a tackifying resin, and further contains if necessary a wax, an antioxidant, a plasticizer, a filler, etc. Examples of the base polymer include an ethylene-vinyl acetate copolymer (EVA), an atactic polypropylene (APP), a polyamide, a thermoplastic polyester, and block polymers (SIS, SBS, SEBS). In the present invention it is preferable to use EVA.

One preferred example of the ethylene-vinyl acetate copolymer is an ethylene-vinyl acetate copolymer resin having a vinyl acetate content of 10 to 30 wt %, a melt flow index (hereinafter called ‘MFR’, also called ‘melt index’) of 1 to 20 g/10 minutes, and a Vicat softening point of 40 to 75° C. For example, Evaflex 360 (manufactured by Du Pont-Mitsui Polychemicals Co., Ltd.) can be used as the base polymer.

If the MFR is greater than 20 g/10 minutes or the Vicat softening point is less than 40° C., then the cohesive strength of the adhesive is insufficient, a sufficient adhesive strength at high temperature cannot be obtained, and when a sealant layer is not provided by coating, a large amount of adhesive soaks in, and there is a possibility that the adhesive might soak through to the pile side of the plush. On the other hand, if the MFR is less than 1 g/10 minutes or the Vicat softening point is higher than 75° C., then the resin extrusion motor of a coating machine is subjected to a large load, the machine tends to break down easily, and it becomes difficult to carry out extrusion coating. The content of the ethylene-vinyl acetate copolymer resin is preferably 30 to 65 wt %. If it is less than 30 wt %, then the adhesive strength is insufficient at low temperature, and if it exceeds 65 wt %, the flowability deteriorates, and uniform and stable coating performance on the light-shielding base fabric (the base fabric section of the light-shielding cloth) cannot be achieved.

It is more preferable to make the content of the ethylene-vinyl acetate copolymer resin 40 to 50 wt %. The preferred ethylene-vinyl acetate copolymer has a vinyl acetate content of 20 to 30 wt %, an MFR of 2 to 5 g/10 minutes, and a Vicat softening point of 40 to 75° C.

The tackifying resin referred to as the other essential component of the hot-melt adhesive is an amorphous oligomer usually having a molecular weight of a few hundreds to a few thousands, and imparts flowability, tack, etc. to a polymer when blended, thus improving the adhesive strength. More specifically, the tackifying resin has properties such as (1) imparting wetting and hot tack when melt-coating, thus improving the adhesion to the surface to be bonded, and (2) controlling the melt viscosity of the blended composition, thus improving the workability. Target physical properties can be easily obtained by appropriately selecting the type and the amount of tackifying resin added. That is, the heat resistance and the open time of the blend can be controlled.

Tackifying resins can be broadly divided into natural resins and synthetic resins.

The natural resins include rosin tackifying resins such as rosin and a rosin derivative (hydrogenated, disproportionated, polymerized, esterified), and terpene tackifying resins such as a terpene resin (α-pinene, β-pinene), a terpene phenol resin, an aromatic modified terpene resin, and a hydrogenated terpene resin.

Examples of the synthetic resin tackifying resins include a petroleum resin, an alkylphenol resin, a xylene resin, and a coumarone-indene resin. The petroleum resin further includes an aliphatic petroleum resin, an aromatic petroleum resin, a copolymer petroleum resin, and alicyclic hydrogenated petroleum resin.

The adhesive used in the present invention contains a hydrogenated tackifying resin as the tackifying resin. Hydrogenating a tackifying resin, that is, adding hydrogen to a double bond portion of the tackifying resin can improve the heat resistance, the weather resistance, and the compatibility with various types of elastomers. In particular, in the case of a hot-melt adhesive, since it is used by heating and melting, the stability to heat is an important issue, and since the hydrogenated tackifying resin is stable to heat, thermal degradation can be suppressed.

The degree of hydrogenation of the hydrogenated tackifying resin of the present invention is preferably at least 70%, more preferably at least 80%, and particularly preferably at least 95%, which is close to saturation. The hydrogenated tackifying resin may be either the above-mentioned natural resin type or the above-mentioned petroleum resin type as long as it is a hydrogenated resin.

The adhesive used in the present invention can of course contain a unhydrogenated tackifying resin as an optional component of the tackifying resin.

Specific examples of the tackifying resin obtained by hydrogenating a natural resin include hydrogenated rosin and hydrogenated terpene. Such tackifying resins obtained by hydrogenating the natural resin are commercially available, for example, under the name of Foral 105 (Rika-Hercules Inc.) as a hydrogenated rosin and under the name of Clearon P-125 (Yasuhara Chemical Co., Ltd.) as a hydrogenated terpene.

The petroleum resin hydrogenated tackifying resins can be broadly divided into aliphatic hydrogenated petroleum resins derived from a C₅ fraction and alicyclic hydrogenated petroleum resins derived from a C₉ fraction. In the present invention, it is preferable to use the alicyclic hydrogenated petroleum resins from the viewpoint of cost and adhesive strength (in particular, polarity).

The alicyclic hydrogenated petroleum resins are hydrogenated aromatic petroleum resins, and are obtained by ring hydrogenation of aromatic petroleum resins, obtained by cationic polymerization of the C₉ fraction of a naphtha cracking oil, in the presence of a catalyst such as aluminum chloride. Representative examples of the C₉ fraction include α-methylstyrene, β-methylstyrene, vinyltoluene, and indene, and hydrogenating these aromatic petroleum resins obtained by the cationic polymerization to a degree of at least 70% can give alicyclic hydrogenated petroleum resins. The degree of hydrogenation of the alicyclic hydrogenated petroleum resins of the present invention is preferably at least 80%, and particularly preferably at least 95%, which is close to saturation.

In the present invention, the alicyclic hydrogenated petroleum resins can be used preferably since they do not have double bonds, which will affect the photographic properties, and are stable compounds that do not affect the photographic properties.

As the tackifying resin, it is preferable to use the aromatic petroleum resin and, in particular, the C₉ component aromatic petroleum resin in combination with the alicyclic hydrogenated petroleum resin. The proportion of the alicyclic hydrogenated petroleum resin in the total of the aromatic petroleum resin and the alicyclic hydrogenated petroleum resin is 10 to 90 wt %, preferably 30 to 70 wt %, and particularly preferably 40 to 60 wt %. An example of the combined composition is cited below.

A combination of an aromatic petroleum resin having a softening point (ring and ball method, JIS K-2531) of 120 to 140° C., for example, Nisseki Neopolymer 140 (Nippon Petrochemicals Co., Ltd.), with an alicyclic hydrogenated petroleum resin having a softening point of 120 to 140° C., for example, Aimarb P-140 (Idemitsu Petrochemical Co., Ltd.).

If the softening point is less than 120° C., then the heat resistance of the adhesive is poor. If it is more than 140° C., then the flowability of the adhesive is poor, and uniform and stable coating performance onto a light-shielding base fabric cannot be achieved. The compositional proportion of the tackifying resin is preferably in the range of 25 to 50 wt %. If it is more than 50 wt %, then the tack of the adhesive is too high, the adhesive adheres to each section of a plush production line where it experiences a thermal history during the production process, the production line might break down, and the final plush might be contaminated by resin deposits. If the proportion of the tackifying resin is less than 25 wt %, there is a tendency to fail to achieve a target adhesive strength. The proportion of the tackifying resin is more preferably 25 to 35 wt %.

In addition to the ethylene-vinyl acetate copolymer as the base polymer and the two types of the tackifying agents, which are essential components, inorganic fine particles such as talc, and a polyethylene wax having a softening point of 90 to 110° C. and having a small molecular weight distribution are preferably added as additives.

The content of the inorganic fine particles is preferably 0 to 20 wt %. If it exceeds 20 wt %, then the flowability of the adhesive deteriorates, uniform and stable coating performance onto the light-shielding base fabric cannot be achieved, and a target adhesive strength cannot be obtained. If the content of the inorganic fine particles is less than 5 wt %, then there is a possibility that the cohesive strength of the adhesive might be insufficient. The content of the inorganic fine particles is therefore more preferably 5 to 15 wt %.

The compositional proportion of the wax added is preferably 0 to 20 wt %. If it exceeds 20 wt %, then the cohesive strength of the adhesive deteriorates, a target adhesive strength cannot be obtained, and the viscosity decreases, thus causing a problem in the impregnated state. When the compositional proportion of the wax is 10 wt % or more, the open time of the adhesive can be short, and there is no possibility of blocking occurring during production of the plush. The compositional proportion of the wax is therefore more preferably 10 to 20 wt %.

These starting materials used for the hot-melt adhesive cannot of course contain any component that changes the performance of the recording material and, in particular, the performance (sensitivity, density, etc.) of the photographic light-sensitive material, to an extent greater than a certain level.

In order to prevent thermal degradation when applying the hot-melt adhesive, it is preferable to add an antioxidant. With regard to the antioxidant, common antioxidants such as those described in ‘Jitsuyo Purasuchikku Jiten (Practical Plastic Dictionary)’ published by the Jiten Publishing Center, Industrial Research Center of Japan, Inc. or ‘Purasucchiku Firumu Rezin Zairyo Soran (Complete List of Plastic Film Resin Materials) 1991 (First volume)’ published by the Converting Technical Institute. The antioxidants can be classified into phenol types, thioether types, and phosphorus types in terms of their structure, and the phenol type is the most standard. However, since there is a possibility that the antioxidant might affect the photographic film performance, when it is used, adequate consideration should be paid thereto, including the amount added.

In order to impart the light-shielding properties to the base fabric, it is also necessary to disperse carbon black in the hot-melt adhesive by sufficiently kneading, for example, 0.2 to 1.0 wt % of Mitsubishi Carbon Black #44 (Mitsubishi Chemical Corp.). If the amount of the carbon black added is less than 0.2 wt %, then the light-shielding properties of the resulting plush are inadequate, the photographic performance is unstable, and the final product film cartridge has problems such as film fogging.

In particular, with regard to the photographic performance, the adsorption characteristics of the carbon black can be expected to have a large influence, as described in ‘Kaabon Burakku Binran (Carbon Black Handbook) (Carbon Black Association)’ published by Tosho Shuppan-sha Co., Ltd. If the carbon black is added at more than 1.0 wt %, not only is the adhesive strength degraded, but also the viscosity increases, and the carbon black easily forms secondary aggregates, thus causing a problem in terms of the coating suitability.

With regard to the carbon black used in the present invention, a general carbon black such as one described in ‘Kaabon Burakku Binran (Carbon Black Handbook) (Carbon Black Association)’ published by Tosho Shuppan-sha Co., Ltd. can be used, and it is particularly preferable to use oil furnace black, which is classified in terms of the production method and the starting material.

The composition of one preferred embodiment of the hot-melt adhesive used in the present invention comprises 30 to 65 wt % of the base polymer (an ethylene-vinyl acetate copolymer resin, etc.); 25 to 50 wt % of the tackifying resin; 0 to 20 wt % of the inorganic fine particles; and 0 to 20 wt % of the wax. The composition of the hot-melt adhesive more preferably comprises 40 to 50 wt % of an ethylene-vinyl acetate copolymer resin having a vinyl acetate content of 20 to 30 wt %, an MFR of 2 to 5 g/10 minutes, and a Vicat softening point of 40 to 75° C.; 25 to 35 wt % of the tackifying resin; 5 to 15 wt % of the inorganic fine particles; and 10 to 20 wt % of the wax.

The form of the hot-melt adhesive used in the present invention and having the above-mentioned composition is preferably a 100% solids type that is solid at room temperature and exhibits flowability when heated. The 100% solids type hot-melt adhesive preferably has a flowability of 50,000 to 300,000 mPa·s when heated to 200° C. The flowability is more preferably in the range of 100,000 to 200,000 mPa·s.

The recording material container employing the adhesive of the present invention can be used as a container for housing a light-insensitive recording material such as an image receiving paper for a heat developable material that is used together with a heat developable photographic light-sensitive material, in addition to a silver halide photographic light-sensitive material. Embodiments of the adhesive include a hot-melt adhesive for bonding a shell-section-forming portion of a cartridge housing a long length of roll-form recording material to a pair of end caps for closing opposite ends of the shell-section-forming portion, a hot-melt adhesive for fixing a cloth bonded to a slit-shaped opening of the cartridge to an upper lip of the slit, and a hot-melt adhesive for fixing a light-shielding cloth to a slit-shaped opening provided in a container for a light-sensitive recording material.

The hot-melt adhesive of the present invention can be produced by various production methods including those described in ‘Secchakuzai no Jissai Chishiki (Practical Knowledge of Adhesives (by T. Okitsu)’ published by Toyo Keizai Inc. and ‘Shin Kobunshi Bunko 16, Hotto Meruto Secchakuzai no Jissai (Hot-melt Adhesives In Practice)’ published by Kobunshi Kankokai KK. In the case where the viscosity is comparatively high, as in the hot-melt adhesive of the present invention, since a problem occurs during a step of cutting into pellet form if the adhesive is only dropped onto an endless steel belt in the form of a line or a biscuit, and cooled and solidified, it is preferable to carry out the cutting after solidifying it in a bath filled with cooling water instead of solidifying using the steel belt.

As in the hot-melt adhesive of the present invention, when the carbon black is added, it can be directly kneaded with a resin using a roll, a Banbury mixer, an extruder, etc., but it is usually kneaded in advance with a small amount of a plasticizer by means of an ink roll to give a paste-like toner, kneaded with a small amount of a resin by means of a roll or an extruder to give master batch color pellets, or mixed uniformly with a small amount of a resin powder using a high speed mixer to give a powder master batch (resin color).

These are then preferably mixed and diluted with a large amount of resin during a processing step to adjust to a predetermined amount of coloring agent. Since a high grade color black having a fine particle size is difficult to disperse, it is useful to exploit the above-mentioned master batch methods as appropriate. Furthermore, as in the hot-melt adhesive of the present invention, when starting materials having very different relative densities such as carbon black and a sealant are added, since it is very difficult to disperse them uniformly, if a continuous kneader such as a twin screw type extruder is used, the resin obtained after one pass often has variations in the physical properties within the same production lot, and it is preferable to charge the resin obtained after one pass to the mixing vessel, thus carrying out two pass kneading. From the viewpoint of preventing oxidative degradation, it is preferable to use an extruder for melting the resin and further to degas (evacuate) the interior of the extruder or purge the interior of the extruder with nitrogen. Moreover, from the viewpoint of preventing thermal degradation, it is preferable to set the melting temperature for the starting materials at 200° C. or below.

Since a 100% solids hot-melt adhesive with no solvent is solid at normal temperature and generally has a high viscosity and poor flowability, when coating the hot-melt adhesive on the reverse side (underside) of the light-shielding cloth, it is preferable to employ an extrusion coating process such as one described in ‘Kotingu Hoshiki (Coating Processes) (by Y. Harasaki)’ published by Maki Publishing. With regard to a method for supplying a hot-melt adhesive used in a coating machine, there is a method in which it is melted by a hot cylinder and supplied by a screw process. The adhesive is applied directly to the reverse side of a plush base material using a coating device of an extrusion die coater.

It is also possible to carry out coating by a nozzle process, a roll process, or a blade process described in ‘Secchaku (Adhesion) Handbook, Second Edition (Ed. by The Adhesive Society of Japan)’, published by The Nikkan Kogyo Shimbun, Ltd. by means of various types of coating machine described in ‘Shin Kobunshi Bunko 16, Hotto Meruto Secchakuzai no Jissai (Hot-melt Adhesives in Practice)’ published by Kobunshi Kankokai KK.

From the viewpoint of minimizing the oxidative degradation and the thermal degradation, the screw process is preferable. Furthermore, it is more preferable to install a nitrogen purging machine in a hopper section, for example, a membrane separator type nitrogen gas generator (Air Water Inc.). Since contamination by foreign matter might cause abnormalities on the coating surface, from the viewpoint of preventing contamination by foreign matter, it is preferable to install a filter on the exit side of the extruder or prior to the die, employ a vibration type foreign matter removal device before charging a resin into a hopper, or use a magnetic type foreign matter removal device having a strong magnetic force so as to remove foreign matter, thus achieving coating stability. In the case of the extrusion coating method, from the viewpoint of preventing thermal degradation and oxidative degradation of the resin, it is preferable not to make any section in which resin can be retained in the extruder, the die, or a heat hose connecting the extruder and the die. In particular, when the retaining section is present within the die, it is preferable to change the flow of resin by installing a rectifying plate or subject a component such as a gear to a boron carbide ceramic coating (Diamond Black Inc.).

When the hot-melt adhesive of the present invention is applied to the underside (reverse side) of the plush base material, the adhesive area is formed from at least one layer of the hot-melt adhesive. The adhesive area may be in the form of stripes or islands but the adhesive layer preferably forms a uniform continuous area and particularly preferably forms a continuous adhesive layer.

When the hot-melt adhesive of the present invention is applied to the underside of the plush material by means of the above-mentioned coating machine, the temperature of the hot-melt adhesive when applied is preferably at a level that does not cause thermal degradation of the light-shielding plush in the case where the light-shielding plush is formed from a synthetic fiber. The synthetic fiber referred to here denotes one formed from a thermoplastic resin such as a polyester, for example, polyethylene terephthalate or a polyamide, for example, nylon. When the plush material is a synthetic fiber such as, for example, polyethylene terephthalate or nylon-66, the temperature of the adhesive when applied is preferably 200° C. or below, and more preferably 150 to 180° C. The viscosity of the hot-melt adhesive when applied needs to be adjusted according to its physical properties and the coating temperature, and is preferably from 100,000 to 700,000 mPa·s, and more preferably 200,000 to 600,000 mPa·s. When it is less than 100,000 mPa·s, there is a possibility that the adhesive might penetrate through to the pile side if the hot-melt adhesive is directly applied onto the underside of the plush material without using a sealant layer. When it exceeds 700,000 mPa·s, the penetration and attachment of the resin to the base fabric are degraded, there is a possibility that a high degree of fraying might be caused during cutting the plush on the production line, and it becomes difficult to carry out smooth and uniform coating.

Moreover, it is desirable when coating to set the equipment conditions so that the clearance between a coating head and a back-up roll is in the range from 0.3 to 1.5 mm. When the clearance is less than 0.3 mm, since the pile is strongly compressed, there is a possibility that the pile might be crushed or the transport characteristics of the base fabric might be degraded. If the clearance is more than 1.5 mm, then the adhesive might not be transferred to the base fabric, and there is a possibility of coating abnormalities such as patchy coating occurring. The amount of adhesive coated is preferably 60 to 120 g/m². When the amount coated is less than 60 g/m², the reverse side of the plush material cannot be leveled. As a result, not only it is not possible to obtain an intended adhesive strength, but also light penetrating through the plush material might not be absorbed. In this case, it is necessary to increase the amount of carbon black added, but if the amount of carbon black added is increased, then not only is there a deterioration in the adhesive strength, but also the viscosity increases, thermal degradation easily occurs, and there is a problem in coating suitability as described above. When the amount coated is more than 120 g/m², in a slitting step of the process for the production of a plush ribbon, there is a possibility that the amount of resin residue attached to the ribbon might increase, and there is also a possibility, in equipment in which a plurality of metal sheets are continuously conveyed in a state in which they are arranged so that the forward end of one sheet is almost in contact with the back end of the preceding sheet, and two long lengths of plush ribbon precoated with an adhesive are continuously bonded to the right and left edges respectively of the metal sheets so arranged as described in JP-A-59-143841, JP-A-63-74869, JP-B-5-53256, and JP-A-7-301888, that the adhesive might be transferred to a cartridge shell when thermocompression-bonding the plush onto the cartridge shell, thereby degrading the appearance of the cartridge.

With regard to the light-shielding cloth suitable for coating with the hot-melt adhesive of the present invention, it is preferable for the pile density on the pile side to be 45,000 to 85,000 filaments/cm² and for the pile compression characteristics to be such that the change in thickness is 15 to 25% under a load of 0.49 N/cm² and 26 to 45% under a load of 1.96 N/cm² when the pile thickness is 1.6 mm or less. The change in thickness referred to here means a proportion of a reduction in thickness due to the load relative to the original thickness. This characteristic can be obtained by appropriately combining the thickness, the cross-sectional shape, the type and the processed form of the pile threads. By imparting the above-mentioned pile density and compression characteristics to the pile threads, the pile threads will not be crushed by a pressure that presses the adhesive into the underside when coating the adhesive. A good quality light-shielding plush having small drawing resistance and good light-shielding properties when used in a film cartridge can thereby be obtained. For example, when an 84 decitex/72 filament polyester processed thread having a single filament size of 1.16 decitex is used at a pile density of 50,000 to 60,000 filaments/cm², the above-mentioned good pile characteristics can be obtained. In the same type of processed thread, when a 84 decitex/36 filaments polyester processed thread having a single filament size of 2.31 decitex is used, the change in thickness with a load of 1.96 N/cm² becomes less than 26%, and although the pile is not crushed during coating, since the drawing resistance of a film cartridge increases, it is preferable for the single filament size to be smaller.

It is necessary for the thickness of the plush to be set according to the gap size of the slit-shaped opening of the cartridge main body to which the plush is bonded, and it is preferably set at a level that is larger than half the gap size by 0.05 to 0.3 mm. When it is larger by less than 0.05 mm the light-shielding properties might be greatly degraded, and when it is larger by more than 0.3 mm the drawing resistance might increase. The base fabric preferably has a woven or warp knitted structure which gives a smooth underside and good coating performance with an adhesive. Among the warp knitted structures, a chain/inlay fabric and a chain/satin fabric disclosed by the present applicant in JU-B-7-50741 (JU-B denotes a Japanese examined utility model application publication) are preferred. The use of such a fabric reduces the roughness of the underside so improving the coating performance, and an intended adhesive strength can be obtained with a smaller amount of adhesive coated. In the case of the chain/inlay fabric, a 56 to 100 decitex multi-filament thread is preferably used; it is also possible to use a combination of filament threads having different decitex values, but in order to introduce an anchoring effect between the adhesive and the fabric, the number of filaments is preferably 45 or below. When the size of the thread exceeds 110 decitex, the slitting performance in an ultrasonic slitting step of the process for producing a plush ribbon might be degraded. When the size of the thread becomes thinner than 56 decitex, the strength of the base fabric becomes poor, the rigidity of the final plush product is degraded, and there is a possibility that the plush might not be able to be bonded stably to a predetermined position of a cartridge main body. The materials for the pile thread and the base fabric thread used for a plush having the above-mentioned warp knitted or woven structure are preferably formed from a single synthetic fiber, but combinations of two or more types of synthetic fiber can be used.

The light-shielding cloth used in the present invention is preferably formed from a black thread and contains an antistatic material and a conductive material as described in JU-B-62-51341 and JU-A-4-33040 in order to ensure the presence of the light-shielding function and prevent the occurrence of static electricity when drawing photographic film. With regard to coloring methods, the whole cloth can be dyed (post dyeing) or a carbon-black-colored thread can be used. The carbon-black-colored thread is formed by kneading thread with carbon black; as described in ‘Purasuchikku Yo Chakushokuzai (Coloring Agents for Plastic) (by Y. Hanada and E. Yasaku) published by The Nikkan Kogyo Shimbun, Ltd., carbon black has good light absorption over a wide range including ultraviolet, visible and infrared light, and it is therefore possible to use it in the case of light-sensitive materials which absorb light at various wavelengths.

The light-shielding cloth used in the present invention can be cut (slit) into a required width after making a wide-width product (500 mm or more) or can be made so as to have a required width in the first place. With regard to methods of slitting the wide-width product while preventing pile drop, there is a method of hot melt cutting by means of a hot blade disclosed in JU-B-48-35790 and, as other means, a method of cutting by means of, for example, an ultrasonic cutter, a laser cutter or a heat cutter.

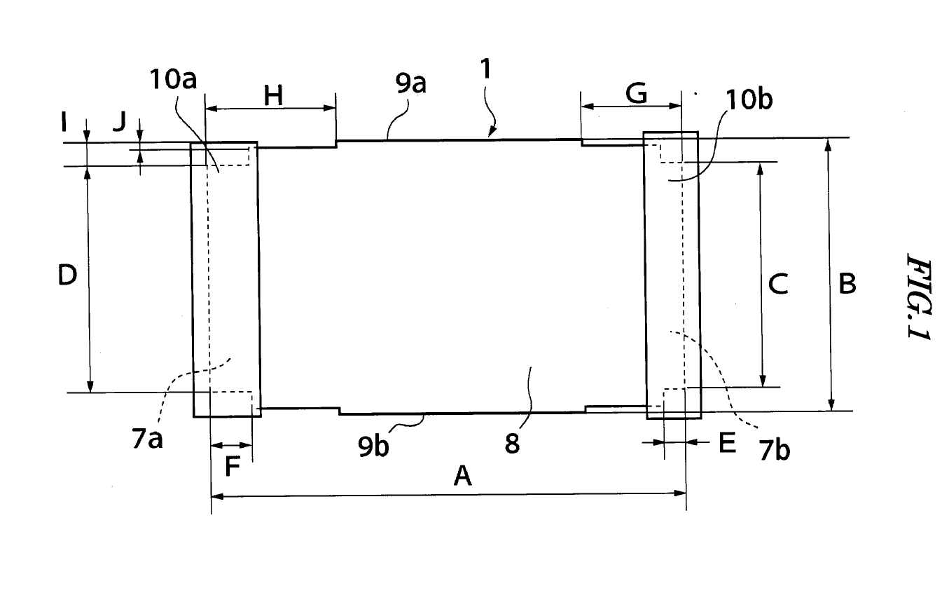

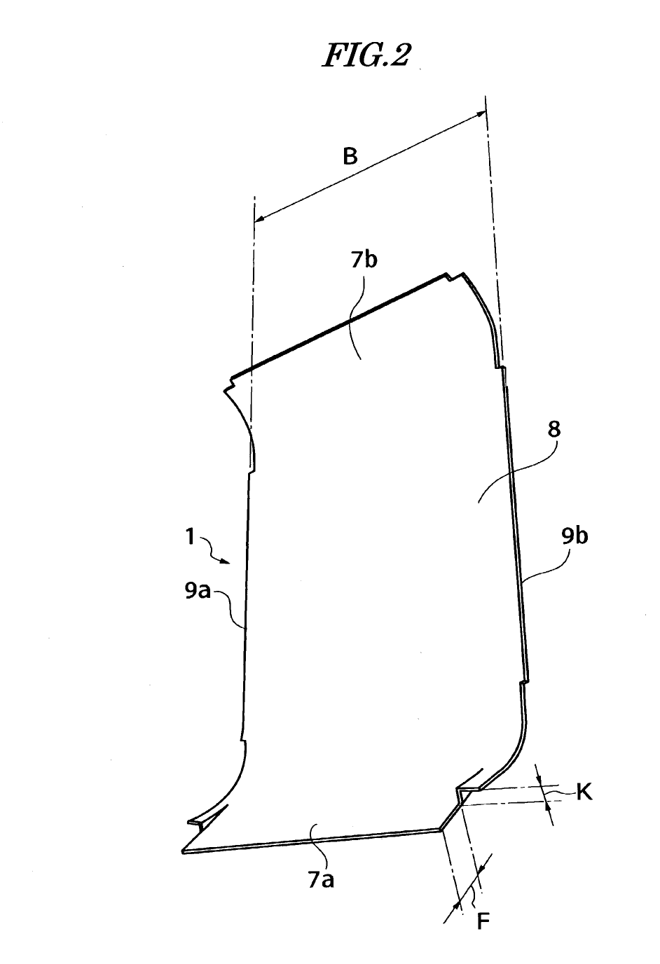

FIG. 1 is a front view of one example of a shell-section-forming metal sheet, to the right and left edges of which light-shielding plush has been bonded using long lengths of the light-shielding plush of the present invention. A shell-section-forming metal sheet 1 comprises port-forming sections 7a and 7b and a tube-forming section 8. Projections 9a and 9b, which are inserted into a lid member (not illustrated) and a base member (not illustrated) of a photographic film cartridge, are formed on the upper and lower parts of the tube-forming section 8. The shell-section-forming metal sheet 1 shown in FIG. 1 has a length A in the width direction of 79.75 to 79.85 mm and a length B in the longitudinal direction of 42.15 to 42.25 mm. The port-forming section 7a has a length D in the longitudinal direction of 35.8 to 36.0 mm and a length F in the width direction of 7.1 to 7.3 mm. The port-forming section 7b has a length C in the longitudinal direction of 35.8 to 36.0 mm and a length E in the width direction of 3.4 to 3.6 mm. A length H in the width direction from the edge of the port-forming section 7a to the edge of the projection 9a of the tube-forming section 8 is 21.15 to 21.40 mm. A length G in the width direction from the edge of the port-forming section 7b to the edge of the projection 9a of the tube-forming section 8 is 17.3 to 17.5 mm. A length I in the longitudinal direction from the edge of the projection 9a of the tube-forming section 8 to the edge of the port-forming section 7a is 3.1 to 3.2 mm. A length J in the longitudinal direction of the projection 9a of the tube-forming section 8 is 0.5 to 0.6 mm. Furthermore, in order to make it easy to fit the lid member or the base member of the photographic film cartridge and in order to prevent the light-shielding plush 10a from becoming detached during the fitting, a 0.4 to 0.6 mm lead-in step K is provided (see FIG. 2).

Two pieces of light-shielding plush 10a and 10b shown in FIG. 1 are both affixed by cutting long lengths of light-shielding plush, which are affixed to the shell-section-forming metal sheet 1, in a position such that opposite ends in the longitudinal direction of each of the plush pieces project beyond the tube-forming section 8 by 1 to 2 mm. The light-shielding plush 10a has a width of 11.3 to 11.7 mm and may also be narrower with a width of 8.8 to 9.7 mm, and the edge in the width direction projects beyond the port-forming section 7a by 1.0 to 2.5 mm. The light-shielding plush 10b has a width of 9.3 to 9.7 mm, and the edge in the width direction projects beyond the port-forming section 7b by 1.0 to 2.5 mm.

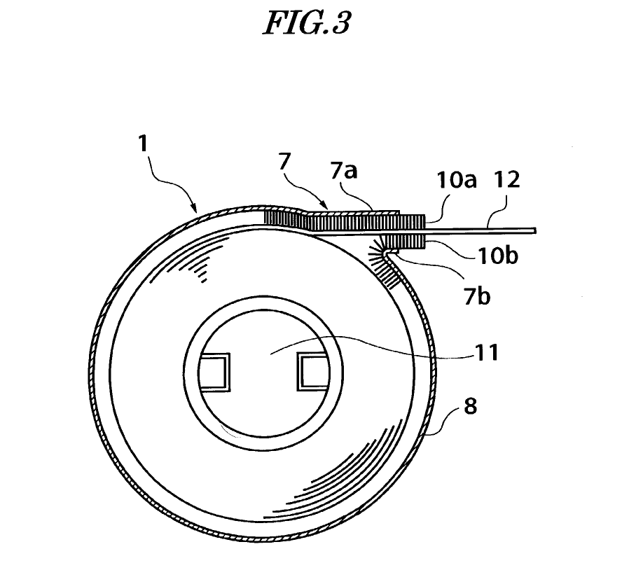

FIG. 3 is a cross section of one example of a photographic film cartridge formed from the shell-section-forming metal sheet with light-shielding plush shown in FIG. 1. A film case of the photographic film cartridge is formed by bending the tube-forming section 8 of the shell-section-forming metal sheet 1 shown in FIG. 1 into a tubular form so that the two pieces of light-shielding plush 10a and 10b bonded to the port forming sections 7a and 7b come into contact with each other. A photographic film 12 wound around a spool 11 is drawn out while the surfaces thereof are in contact with the two pieces of light-shielding plush 10a and 10b of a port section 7, and the photographic film inside the cartridge is thus shielded from light.

There is no restriction on the width of the light-shielding plush pieces 10a and 10b as long as they are in contact with the photographic film to an extent that can prevent the photographic film housed inside the cartridge from being exposed to light. For example, it is possible to make two pieces of light-shielding plush 10a and 10b with a width of 8.8 to 9.7 mm (the width corresponding to the depth from the port orifice of the photographic film cartridge). In particular, taking into consideration the production yield and control of the production of the light-shielding plush, it is preferable for the two pieces of light-shielding plush 10a and 10b to have a narrow and identical width. In addition, when the two pieces of light-shielding plush 10a and 10b have a width of 8.8 to 9.7 mm, the length F in the width direction of the port forming section 7a of the shell-section-forming metal sheet 1 shown in FIG. 1 is preferably 3.5 to 4.0 mm so as to enhance the light-shielding properties of the photographic film cartridge. Moreover, when the width of the plush is reduced from 11.3-11.7 mm to 8.8-9.7 mm, it is preferable to also reduce the length F, and in order to fit the lid member or the base member of the photographic film cartridge, it is also preferable for the height of the lead-in step K to be increased from 0.4-0.6 mm to 1.5-2.5 mm.

FIG. 2 shows a perspective view of one example of the shell-section-forming metal sheet 1 to which the plush will be attached, where the step K is preferably large when the width of the plush is narrow.

After slitting, the narrow-width light-shielding cloth so formed is wound around a plastic reel while traversing from the top to the bottom of the reel. If the wind tension at this point is too low, the wound form collapses during transport, and it becomes impossible to draw out the narrow light-shielding cloth on-site. When the wind tension is too high, the pile is crushed so causing degradation of the light-shielding properties.

The above-mentioned cartridge shell sheet is formed by, for example, firstly cutting a metal sheet into a predetermined shape, forming the sheet into a shape having a substantially boat-shaped cross section, bonding the above-mentioned two pieces of plush to the right and left edges of the metal sheet and then bending the metal sheet into a substantially tube shaped form so that the two pieces of plush face each other.

With regard to methods of bonding the plush to the metal sheet, there is a method in which the plush is cut to a predetermined length beforehand, the metal sheet is fed intermittently and the precut plush is bonded to the metal sheet piece by piece when the sheet is stopped, and methods disclosed in JP-A-59-143841, JP-A-63-74869, JP-B-5-53256, and JP-A-7-301888 for enhancing the productivity by increasing the speed of the bonding step. In the practical methods with enhanced productivity, a plurality of metal sheets are continuously fed in a state in which they are arranged so that the forward end of one sheet is almost in contact with the back end of the preceding sheet, two long lengths of the plush precoated with an adhesive are continuously bonded to the right and left edges respectively of the metal sheets so arranged, and this is followed by cutting by passing a cutter blade between adjoining metal sheets.

The light-shielding cloth of the present invention can be used as, for example, a light-shielding cloth provided at an outlet of a cartridge for various types of light-sensitive material such as, for example, photographic film, photographic printing paper and photosensitive resin film, and as a lining for the purpose of light-shielding in a machine such as a photographic developing machine for light-sensitive material. In particular, the film cartridge of the present invention can house various types of photographic film in a light-shielding manner and they can be stored for a long period without the photographic performance deteriorating. It can desirably be applied to a container having a structure in which film is drawn out through an outlet, particularly desirably a cartridge housing various types of sheet-form or roll-form photographic material (JIS 135 size photographic film, color photographic printing paper, computer phototypesetting film and paper, thermal paper, light-sensitive resin film, microfilm, X-ray film, etc.), but it is also suitable for housing a light-sensitive material sensitized by a known method such as addition of a sensitizer such as a sulfur sensitizer, a reduction sensitizer, or a gold sensitizer to a silver halide emulsion, and it is particularly suitable for housing a reduction-sensitized light-sensitive material.

### EXAMPLES

The present invention will be explained in detail below by reference to examples, but the present invention is not limited thereto.

### Example 1

The constitution of the light-shielding plush having a knitted structure was a chain/inlay fabric disclosed in JU-B-7-50741, in which the plush was formed using 84 decitex/36 filaments polyester threads as the chain and inlay threads of the base fabric and an 84 decitex/72 filaments polyester processed thread as the pile thread. Two layers of the base fabric were knitted together by the pile thread using a double Raschel machine so that the knitting gauge was 22 and the course density was 50. The two sheets of base fabric so obtained were cut centrally to give two pieces of light-shielding knitted pile. The pile thread so cut had a length of 2.2 mm. The polyester processed thread used as the pile thread was obtained by heating twice using a 3-shaft outer-contact type false twist friction texturing machine. The base fabric obtained by cutting centrally in this way was then subjected to a pre-shearing step in which the length of the pile was adjusted as appropriate and the pile was brushed while heating at 120° C. The pile was further subjected to a preset step in which the pile was crimped by heating at 190° C., a dyeing step for the purpose of imparting light-shielding properties, and then a drying step. The pile was finally subjected to a shearing step to adjust the length of the pile to 1.4 mm. As a result, a light-shielding base fabric having a compression characteristic that showed a change in thickness of 20% with a load of 0.49 N/cm² and a change in thickness of 32% with a load of 1.96 N/cm² when the pile thickness was 1.4 mm was obtained. The course density was 50, the wale density was 26 and the pile density was 58,000 filaments/cm².

In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C. In order to impart light-shielding properties, 0.3 wt % of carbon black (C. B.) produced by the oil furnace method and having a particle size of 24 nm, a DBP oil absorption of 76 ml/100 g as a powder, and a pH of 8.0 was further added to the hot-melt adhesive and kneaded together with 0.3 wt % of a phenolic antioxidant for preventing oxidative deterioration of the resin. The mixture was kneaded well by passing it twice through a twin screw type extruder to disperse the carbon black. The hot-melt adhesive so prepared was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 152,500 mPa·s (200° C.). The light-shielding base fabric so obtained was ultrasonically slit into 11.5 mm and 9.5 mm widths to give the light-shielding plush of the present invention.

Subsequently, two long lengths of the plush so formed were continuously bonded to right and left edges of each of a plurality of cartridge shell-section-forming sheets while employing conveying means for continuously conveying the plurality of sheets arranged so that the forward end and the back end of adjoining sheets were in close contact with each other, that is to say, the right edges and the left edges of the sheets were each arranged in a line, and pressing means for compression bonding the two long plush ribbons precoated with adhesive against the right and left edges of the sheets that were being conveyed. The long plush ribbons so bonded were cut from their reverse sides between each of the sheets to give cartridge shell sheets. An ISO 400 sensitivity color negative film was wound around spools and housed in cartridges formed from each of the shell sheets, and quality characteristics such as light-shielding properties and drawing resistance were evaluated in this state. The ISO 400 sensitivity color negative film had a base coated with silver halide emulsion D (with 8.0×10⁻⁷ mol of thiourea dioxide per mole of silver halide added as a reduction sensitizer) disclosed in JP-A-9-189980.

### Comparative Example 1

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type hot-melt adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C., and was produced by passing it once through a twin screw type extruder. The hot-melt adhesive so prepared with this composition was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 156,000 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 2

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C. In order to impart light-shielding properties, 0.3 wt % of the same carbon black as in Example 1 was further added to the hot-melt adhesive and kneaded. The mixture was kneaded well by passing it twice through a twin screw type extruder to disperse the carbon black. The hot-melt adhesive so prepared was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 152,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 3

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 15 wt % of a polyethylene wax having a softening point of 100° C., 10 wt % of talc, and 30 wt % of an aromatic petroleum tackifier having a softening point of 140° C. In order to impart light-shielding properties, 0.3 wt % of the same carbon black as in Example 1 was further added to the hot-melt adhesive and kneaded. The mixture was prepared by passing it once through a twin screw type extruder to disperse the carbon black. The hot-melt adhesive so prepared was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 156,000 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 4

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C. In order to impart light-shielding properties, 0.3 wt % of the same carbon black as in Example 1 was further added to the hot-melt adhesive and kneaded together with 0.3 wt % of a phenolic antioxidant for preventing oxidative degradation of the resin. The mixture was kneaded well by passing it twice through a twin screw type extruder to disperse the carbon black. The hot-melt adhesive so prepared was coated at 60 g/m² on the underside of the light-shielding base fabric at a resin temperature of 175° C. using a GPD hot-melt die coater (manufactured by Yuri Roll Machine Co., Ltd.). The viscosity of the hot-melt adhesive was 152,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 5

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C. In order to impart light-shielding properties, 1.0 wt % of the same carbon black as in Example 1 was further added to the hot-melt adhesive and kneaded. The mixture was kneaded well by passing it twice through a twin screw type extruder to disperse the carbon black. The hot-melt adhesive so prepared was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 182,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 6

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was an ethylene-vinyl acetate type adhesive containing 45 wt % of an ethylene-vinyl acetate copolymer resin having a vinyl acetate content of 26 wt %, a melt index of 2 g/10 minutes and a Vicat softening point of 54° C., 30 wt % of an aromatic petroleum resin tackifier having a softening point of 140° C., 10 wt % of talc, and 15 wt % of a polyethylene wax having a softening point of 100° C. In order to impart light-shielding properties, 0.3 wt % of the same carbon black as in Example 1 was further added to the hot-melt adhesive and kneaded together with 0.2 wt % of a phosphorus type antioxidant for preventing oxidative degradation of the resin. The mixture was kneaded well by passing it twice through a twin screw type extruder to disperse the carbon black. The hot-melt adhesive so prepared was coated at 100 g/m² on the underside of the light-shielding base fabric at a resin temperature of 175° C. using a GPD hot-melt die coater (manufactured by Yuri Roll Machine Co., Ltd.). The viscosity of the hot-melt adhesive was 156,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 7

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C.

The hot-melt adhesive was an ethylene-vinyl acetate type adhesive containing 15 wt % of an aromatic petroleum resin tackifier having a softening point of 140° C., 15 wt % of an alicyclic hydrogenated petroleum tackifying resin having a softening point of 140° C. and a degree of hydrogenation of at least 95%, 45 wt % of an ethylene-vinyl acetate copolymer resin having a vinyl acetate content of 26 wt %, a melt index of 2 g/10 minutes and a Vicat softening point of 54° C., 10 wt % of talc, and 15 wt % of a polyethylene wax having a softening point of 100° C. In order to impart light-shielding properties, 0.7 wt % of carbon black produced by the oil furnace method and having a particle size of 24 nm, a DBP oil absorption of 76 ml/100 g as a powder, and a pH of 8.0 was further added to the hot-melt adhesive and kneaded together with 0.3 wt % of a phenolic antioxidant for preventing oxidative degradation of the resin. The mixture was kneaded well by passing it twice through a twin screw type extruder to disperse the carbon black. The hot-melt adhesive so prepared was coated at 90 g/m² on the underside of the light-shielding base fabric at a resin temperature of 175° C. using a GPD hot-melt die coater (manufactured by Yuri Roll Machine Co., Ltd.). The viscosity of the hot-melt adhesive was 132,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 8

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was prepared in the same manner as in Example 7 except that 10 wt % of an aromatic petroleum resin tackifier having a softening point of 140° C. and 20 wt % of an alicyclic hydrogenated petroleum tackifying resin having a softening point of 140° C. and a degree of hydrogenation of at least 95% were used. The hot-melt adhesive having the above-mentioned composition was coated at 90 g/m² on the underside of the light-shielding base fabric at a resin temperature of 175° C. using a GPD hot-melt die coater (manufactured by Yuri Roll Machine Co., Ltd.). The viscosity of the hot-melt adhesive was 125,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 9

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was prepared in the same manner as in Example 7 except that 20 wt % of an aromatic petroleum resin tackifier having a softening point of 140° C. and 10 wt % of an alicyclic hydrogenated petroleum tackifying resin having a softening point of 140° C. and a degree of hydrogenation of at least 95% were used. The hot-melt adhesive having the above-mentioned composition was coated at 90 g/m² on the underside of the light-shielding base fabric at a resin temperature of 175° C. using a GPD hot-melt die coater (manufactured by Yuri Roll Machine Co., Ltd.). The viscosity of the hot-melt adhesive was 133,750 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

### Example 10

A base fabric was prepared in the same manner as in Example 1. In order to apply to the underside of the light-shielding base fabric so prepared a sealant for preventing penetration of an adhesive into the surface of the base fabric when coating the base fabric with the adhesive, and in order to form an adhesive layer for bonding the light-shielding base fabric to the cartridge main body, the underside of the base fabric was coated with 55 g/m² (dry weight) of a vinyl acetate emulsion as the sealant and then a 100% solids hot-melt adhesive so as to form an adhesive layer. The vinyl acetate emulsion used here had a solids content of 50% and a viscosity of 100,000 mPa·s at 25° C. The hot-melt adhesive was prepared in the same manner as in Example 7 except that 15 wt % of an aromatic petroleum resin tackifier having a softening point of 140° C., 15 wt % of an alicyclic hydrogenated petroleum tackifying resin having a softening point of 140° C. and a degree of hydrogenation of at least 95% and, in order to impart light-shielding properties, 0.3 wt % of carbon black produced by the oil furnace method and having a particle size of 24 nm, a DBP oil absorption of 76 ml/100 g as a powder, and a pH of 8.0 were used. The hot-melt adhesive having the above-mentioned composition was coated at 90 g/m² on the underside of the light-shielding base fabric at a resin temperature of 175° C. using a GPD hot-melt die coater (manufactured by Yuri Roll Machine Co., Ltd.). The viscosity of the hot-melt adhesive was 127,500 mPa·s (200° C.). The light-shielding base fabric so obtained was ultrasonically slit into 11.5 mm and 9.5 mm widths to give the light-shielding plush of the present invention. The procedure of Example 1 was repeated from this point to give a sample.

TABLE 1

| | Ex. | Ex. | Ex. | Ex. | Ex. | Ex. | Comp. |
|---|---|---|---|---|---|---|---|
| | 1 | 2 | 3 | 4 | 5 | 6 | 1 |
| Adhesive | | | | | | | |
| C.B. concentration [wt %] | 0.3 | 0.3 | 0.3 | 0.3 | 1 | 0.3 | 0 |
| Antioxidant [wt %] | 0.3*¹ | 0 | 0 | 0.3*¹ | 0 | 0.2*² | 0 |
| Inorganic particles [wt %] | 10 | 10 | 10 | 10 | 10 | 10 | 10 |
| Passes through production | 2 | 2 | 1 | 2 | 2 | 2 | 1 |
| machine | | | | | | | |
| Adhesive coating | | | | | | | |
| Amount of coating [g/m²] | 100 | 100 | 100 | 60 | 100 | 100 | 100 |
| Thickness after coating | 1.55 | 1.55 | 1.55 | 1.55 | 1.55 | 1.55 | 1.55 |
| adhesive [mm] | | | | | | | |
| Coating quality | AA | BB | BB | AA | BB | AA | AA |
| Equipment suitability | | | | | | | |
| Suitability for ultrasonic slitting | AA | AA | AA | AA | AA | AA | AA |
| Quality | | | | | | | |
| Adhesive strength | 300 | 300 | 300 | 100 | 100 | 300 | 500 |
| [gf/11.5 mm] | | | | | | | |
| Light-shielding properties | AA | AA | AA | BB | AA | AA | CC |
| Photographic properties ΔFOG | ≦0.02 | ≦0.02 | ≦0.02 | ≦0.02 | ≦0.02 | ≦0.02 | 0.03 |

*¹Phenolic antioxidant
*²Phosphorus type antioxidant

TABLE 2

| | Ex. | Ex. | Ex. | Ex. |
|---|---|---|---|---|
| | 7 | 8 | 9 | 10 |
| Adhesive | | | | |
| C.B. concentration [wt %] | 0.7 | 0.7 | 0.7 | 0.3 |
| Proportion of aromatic petroleum | 15 | 10 | 20 | 15 |
| resin tackifying resin [wt %] | | | | |
| Proportion of alicyclic hydro- | 15 | 20 | 10 | 15 |
| genated petroleum resin tackifying | | | | |
| resin [wt %] | | | | |
| Degree of hydrogenation of | ≧95 | ≧95 | ≧95 | ≧95 |
| alicyclic hydrogenated petroleum | | | | |
| resin tackifying resin [%] | | | | |
| Equipment suitability | | | | |
| Coating quality | AA | AA | AA | AA |
| Suitability for ultrasonic slitting | BB | BB | BB | BB |
| Quality | | | | |
| Adhesive strength [N/11.5 mm] | 4.90 | 2.94 | 3.92 | 4.90 |
| Light-shielding properties | AA | AA | AA | AA |
| Photographic properties ΔFOG | ≦0.02 | ≦0.02 | ≦0.02 | ≦0.02 |

From the results of Table 1 and Table 2, it could be confirmed that the products of the present invention were superior to the conventional product in terms of both equipment suitability and quality. Here, M denotes very good, BB denotes applicable without problem, and CC denotes applicable with the possibility of a problem occurring, which is preferably to be improved.

Evaluation Methods

Thickness: Measured using a Peacock dial gauge Model G.

Coating quality: An adhesive was applied at a speed of 3 m/min to the underside (reverse surface) of a 500 mm wide light-shielding cloth using a GPD hot-melt die coater (manufactured by Yuri Roll Machine Co., Ltd.). After coating, the quality of the coated surface and the amount of particulates were inspected visually. The particulates were ranked as M when the number per 100 m of the base fabric was less than 5, BB when it was 5 or more but less than 10, and CC when it was 10 or more.

Suitability for ultrasonic slitting: Slitting was carried out using an ultrasonic slitter at a frequency of 15 KHz and an amplitude of 40 μm at a speed of m/min. The state and the amount of resin residue attached to the ribbon after slitting were inspected visually.

AA: The number of pieces of resin residue attached per 10 m of the narrow light-shielding cloth was less than 10.

BB: The number was 10 or more but less than 30.

CC: The number was 30 or more.

Adhesive strength: A ribbon sample slit (cut) into a 11.5 mm width was pressure bonded to the inner surface of a metal sheet that was used as a cartridge shell sheet at 140° C. with a load of 110 gf/cm² for 3 seconds, allowed to stand at 23° C. for 24 hours and subjected to a 180° peel test using a Strograph tester equipped with a high temperature, high humidity chamber set at 80° C. (manufactured by Toyo Seiki Co., Ltd.) at a pulling speed of 300 mm/min.

Light-shielding properties: A sample was conditioned by standing at room temperature for 24 hours and then exposed to light by applying light at 90,000 lux to the port opening, the photographic film was developed and the photographic image was inspected visually in terms of light exposure due to light invasion.

Photographic Properties

An adhesive and an emulsion-coated surface of a color photographic light-sensitive material formed from silver halide emulsion D (with 8.0×10⁻⁷ mol of thiourea dioxide per mole of silver halide added as a reduction sensitizer) disclosed in JP-A-9-189980 were superimposed and housed within a light-shielding and moisture-proof laminated material, and the laminated material was sealed by heat sealing, then allowed to stand in a high temperature, high humidity chamber at 60° C. for 3 days. After standing, the photographic light-sensitive material was taken out of the laminated material, subjected to a wedge exposure to white light, and developed by a standard method. The fogging density (density in an unexposed area) of the developed photographic light-sensitive material was measured using a film density measuring machine. A difference (AFOG) was calculated from this fogging density and a fogging density (density in an unexposed area) of a photographic light-sensitive material that was subjected to standing without the evaluation sample superimposed thereon, exposed to light, and developed under the above-mentioned conditions. The AFOG shown in Table 1 is a value for an emulsion layer (blue sensitive layer), which is the uppermost layer of the color photographic light-sensitive material.

### EFFECTS OF THE INVENTION

The present invention can provide an adhesive-coated light-shielding cloth that is inexpensive, has sufficient adhesive strength, satisfactory ultrasonic slitting and coating suitability, and satisfactory light-shielding properties and, using this cloth, a light-shielding container for a light sensitive material such as a photographic film. Furthermore, the present invention can provide a light-shielding cloth that does not degrade the photographic properties of a light sensitive material having a reduction-sensitized silver halide emulsion and, using this cloth, a light-shielding container for a light sensitive material such as a photographic film.

What is claimed is:

1. A light-shielding cloth comprising a base fabric and an adhesive provided as a coating on the reverse side of the base fabric, the adhesive containing carbon black.

2. A light-shielding container for a light-sensitive material, the container having a slit-shaped opening through which the light-sensitive material is inserted into and taken out of the container, wherein the light-shielding cloth according to claim 1 is bonded to the opening.

3. The light-shielding cloth according to claim 1, wherein the adhesive is a hot-melt adhesive.

4. A recording material container comprising use of an adhesive containing a hydrogenated tackifying resin as a tackifying resin component.

5. A cloth comprising a base fabric and an adhesive provided as a coating on the reverse side of the base fabric, the adhesive containing a hydrogenated tackifying resin as a tackifying resin component.

6. The recording material container according to claim 4, wherein the hydrogenated tackifying resin is an alicyclic hydrogenated petroleum resin.

7. The cloth according to claim 5, wherein the hydrogenated tackifying resin is an alicyclic hydrogenated petroleum resin.

8. The recording material container according to claim 4, wherein carbon black is added to the adhesive.

9. The cloth according to claim 5, wherein carbon black is added to the adhesive.

10. The recording material container according to claim 6, wherein carbon black is added to the adhesive.

11. The cloth according to claim 7, wherein carbon black is added to the adhesive.

12. A light-shielding container for a light-sensitive material, the container having a slit-shaped opening through which the light-sensitive material is inserted into and taken out of the container, wherein the cloth according to claim 5 is bonded to the opening, the cloth having light-shielding properties.

13. A light-shielding container for a light-sensitive material, the container having a slit-shaped opening through which the light-sensitive material is inserted into and taken out of the container, wherein the cloth according to claim 7 is bonded to the opening, the cloth having light-shielding properties.

14. A light-shielding container for a light-sensitive material, the container having a slit-shaped opening through which the light-sensitive material is inserted into and taken out of the container, wherein the cloth according to claim 9 is bonded to the opening, the cloth having light-shielding properties.

15. A light-shielding container for a light-sensitive material, the container having a slit-shaped opening through which the light-sensitive material is inserted into and taken out of the container, wherein the cloth according to claim 11 is bonded to the opening, the cloth having light-shielding properties.

16. The light-shielding container for a light-sensitive material according to claim 12, wherein the adhesive is a hot-melt adhesive.

17. The light-shielding container for a light-sensitive material according to claim 12, wherein the hydrogenated tackifying resin has a degree of hydrogenation of at least 80%.

18. The light-shielding container for a light-sensitive material according to claim 12, wherein the light-sensitive material is a 135 type film cartridge.

19. The light-shielding container for a light-sensitive material according to claim 12, wherein the container houses a photographic film employing a reduction-sensitized silver halide emulsion.
